(19) United States
(12) Patent Application Publication
(10) Pub. No.: US 2020/0242552 A1
(43) Pub. Date: Jul. 30, 2020

(54) SYSTEMS AND METHODS FOR PROVIDING A PORTER SERVICE

(71) Applicant: Honda Motor Co., Ltd., Tokyo (JP)

(72) Inventors: Michael T. Sailer, Whittier, CA (US); Mariko K. Schimmel, Rancho Palos Verdes, CA (US); Katie C. Wallace, Long Beach, CA (US)

(21) Appl. No.: 16/258,068

(22) Filed: Jan. 25, 2019

(51) Int. Cl. G06Q 10/08; H04W 4/029; G05D 1/02

(52) U.S. Cl. CPC G06Q 10/0835; H04W 4/029; G05D 1/0285; G06Q 10/0836; G05D 1/0225

(57) ABSTRACT

Systems and methods for providing a porter service with a conveyance device used to carry cargo on behalf of a user are described. A method for providing a porter service may include receiving a target for the conveyance device at an origin. The method also includes determining a logistical strategy for traversing a path between the origin and the target based on the target and a traversal mode. The method further includes identifying a companion signal associated with a companion vehicle. The method includes generating execution data for traversing the path according to the logistical strategy. The companion vehicle provides the conveyance device with transportation on at least a portion of the path.

### BACKGROUND

As transportation becomes more efficient, travel becomes more ubiquitous. However, travel typically entails user's bringing assorted paraphernalia, such as change(s) of clothes, toiletries, diapers, snacks, bottles, magazines, and toys, among others. Whether it is a lone business traveler with a single case or a large family with multiple bags (e.g., luggage, toiletry case, diaper bag, stroller, etc.), transporting the paraphernalia can be challenging. For example, the user may have to traverse a long distance, over a long time period, and/or the weight of the paraphernalia. Accordingly, the paraphernalia can reduce the user's ability to travel.

### BRIEF DESCRIPTION

According to one aspect, a computer-implemented method for providing a porter service with a conveyance device used to carry cargo on behalf of a user are described. A method for providing a porter service may include receiving a target for the conveyance device at an origin. The method also includes determining a logistical strategy for traversing a path between the origin and the target based on the target and a traversal mode. The method further includes identifying a companion signal associated with a companion vehicle. The method includes generating execution data for traversing the path according to the logistical strategy. The companion vehicle provides the conveyance device with transportation on at least a portion of the path.

According to another aspect, a system for providing a porter service with a conveyance device used to carry cargo on behalf of a user are described. The system includes a receiving module, a logistical module, a companion module, and a data module. The receiving module receives a target for the conveyance device at an origin. The logistical module determines a logistical strategy for traversing a path between the origin and the target based on the target and a traversal mode. The companion module identifies a companion signal associated with a companion vehicle. The data module provides execution data for traversing the path according to the logistical strategy. The companion vehicle provides the conveyance device with transportation on at least a portion of the path.

According to a further aspect, a non-transitory computer-readable storage medium storing instructions that, when executed by a computer, causes the computer to perform a method. The method in includes receiving a target for a conveyance device at an origin. The method also includes determining a logistical strategy for traversing a path between the origin and the target based on the target and a traversal mode. The method further includes identifying a companion signal associated with a companion vehicle. The method includes generating execution data for traversing the path according to the logistical strategy. The companion vehicle provides the conveyance device with transportation on at least a portion of the path.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings.

FIG. 1 is a schematic diagram of a user environment for providing a porter service to an exemplary embodiment.

FIG. 2 is a schematic diagram of an operating environment for providing a porter service according to an exemplary embodiment.

FIG. 3 is a schematic diagram of a user environment having a modified path according to an exemplary embodiment.

FIG. 4 is a schematic view of an exemplary interface for providing a porter service according to one embodiment.

### DETAILED DESCRIPTION

The systems and methods discussed herein are generally directed to providing a porter service that facilitates transportation of cargo on an outing using a conveyance device that is at least partially autonomous. A logistical strategy coordinates the functioning of the conveyance device. The logistical strategy of the conveyance device is based on the target of the outing as well as a traversal mode. The porter service also allows a user to request a conveyance device and a companion vehicle. In some embodiments, the porter service can connect to a portable device of the user.

The conveyance device may travel within a vehicle and/or independently from the vehicle. For example, suppose the conveyance device is sent by the user to pick up a package at a residential location. The conveyance device may travel within a vehicle to the driveway of the residential location, but travel independently of the vehicle to the front door. Alternatively, the conveyance device may be keyed to a user. For example, the conveyance device may be keyed to the user so that the conveyance device follows the user at a predetermined distance. In another embodiment, the user may be able to park the conveyance device at a designated location, for example, where the conveyance device can be charged. The conveyance device may be able to accept deliveries from third parties. For example, the conveyance device may travel to a centralized hub where packages can be received, and then travel to the user or a location to deliver the package. Accordingly, the conveyance device may have tiered security levels so that different parties can access different compartments. For example, parents may put restricted access on some compartments so that kids cannot access or a user may restrict access to one compartment to keep their personal items safe but allow access to another compartment so that outside services might deliver a package.

As an additional example, suppose a family is on a trip in the city and is splitting up to enjoy different activities. At any given time a family member might access the conveyance device using some sort of security feature such as voice recognition, finger print recognition, RFID, QR code, Key Fob, Key, etc. In addition, digital access (e.g. QR code) may allow outside services to deliver goods to conveyance device. In some embodiments, a traversal mode may be used so that the conveyance device is able to determine a desirable location based on all of the users' locations. For example, there may be 5 people in the user group, each of them in a different location and each should be within the same approximate distance to the conveyance device at any given time. The conveyance device may record access data, such as who accessed the device, at what time, what location, etc. In another embodiment, the conveyance device may facilitate user communication. For example, a user within the user group may communicate their activities to other users in their group, such as ‘I picked up snacks and left them in the conveyance device if anyone is hungry.’ The conveyance device may have various security features such as locking wheels, alarms, notifications to the user and so forth to deter and/or alert user of theft or vandalism.

### DEFINITIONS

The following includes definitions of selected terms employed herein. The definitions include various examples and/or forms of components that fall within the scope of a term and that can be used for implementation. The examples are not intended to be limiting. Further, the components discussed herein, can be combined, omitted or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Processor Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication,” as used herein, refers to a communication between two or more computing devices (e.g., computer, personal digital assistant, cellular telephone, network device, vehicle, vehicle computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), cloud communications, a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein can include input and/or output devices for receiving input and/or devices for outputting data. The input and/or output can be for controlling different vehicle features which include various vehicle components, systems, and subsystems. Specifically, the term “input device” includes, but it not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware-based controls, interfaces, touch screens, touch pads or plug and play devices. An “output device” includes, but is not limited to: display devices, and other devices for outputting information and functions.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Conveyance device,” as used herein, refers to any device designed to assist a user in transporting objects. Conveyance devices include, but are not limited to, cart, trolley, wagon, carriage, chariot, transport, trucks, etc. In some embodiments, the conveyance device can include various sensors for sensing and determining various parameters of a user. For example, location, motion, and physiological parameters, among others. Some conveyance devices have user input and output functionality.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk, data store, and/or a memory.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Display,” as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be accessible through various devices, for example, though a remote system. The display may also be physically located on a portable device, conveyance device, or vehicle.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Portable device,” as used herein, is a computing device typically having a display screen with user input (e.g., touch, keyboard, voice, etc.) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

“User,” as used herein can include, but is not limited to, one or more biological beings such as an adult, a child, an infant, or an animal.

“Vehicle,” as used herein, refers to any moving vehicle that is capable of carrying one or more users and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more users and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle can carry one or more users. Further, the term “vehicle” can include vehicles that are automated or non-automated with pre-determined paths or free-moving vehicles.

“Vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system among others.

### I. System Overview

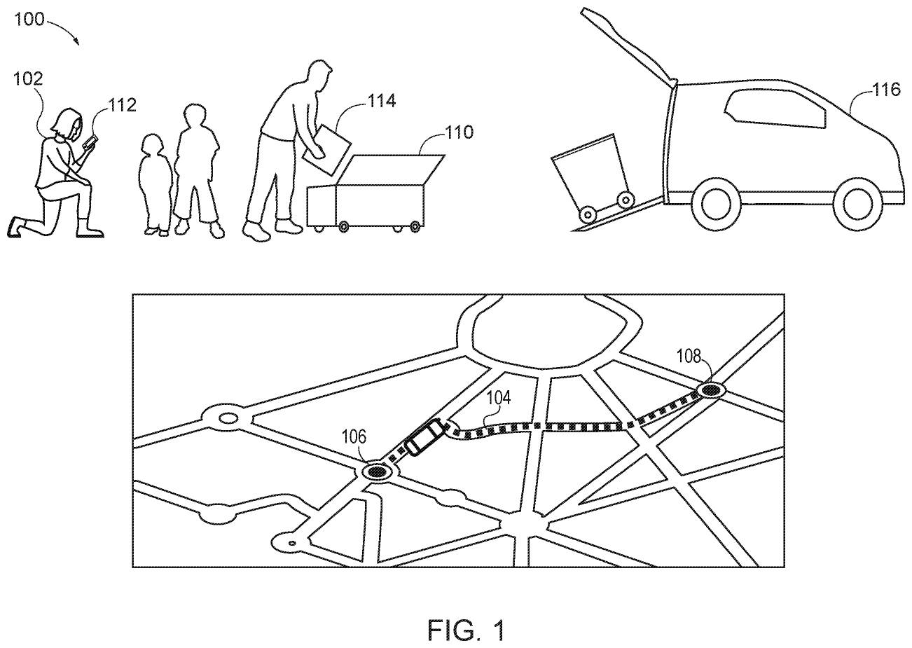

Generally, the systems and methods disclosed herein are directed to providing a porter service for a user. Referring now to the drawings, wherein the showings are for purposes of illustrating one or more exemplary embodiments and not for purposes of limiting same, FIG. 1 is a schematic diagram of a user environment 100 for implementing systems and methods for providing a porter service for the user.

In the illustrated embodiment of FIG. 1, the user environment 100 includes a user 102 that desires to travel on a path 104 from an origin 106 to a target 108 for an outing. The user 102 generates a request having one or more logistical factors. The logistical factors identify, at least in part, a target for a conveyance device 110. In one embodiment, the target 108 may be a physical destination. Then, the logistical factors may include, but are not limited to, at least a portion of the path 104, the origin 106, the target 108, address, coordinates, point of interest, one or more roadway names, and a waypoint. The logistical factors also be an event, invitation, ticket, or other item associated with a time or location. For example, the logistical factors may include a time of arrival, appointment time, the time an event is scheduled to start, a time of departure, the duration of the outing, among others.

In another embodiment, the target 108 may be the user 102. For example, the one or more logistical factors may identify a portable device 112 of the user. For example, the logistical factors may include a media access control address (MAC address), internet protocol address (IP address), radio-frequency identification (RFID) signal. For example, the user 102 and the target 108 may have identifiers that distinguish them from other users or targets. Accordingly, a signal mechanism between the conveyance device 110 and the user 102 may facilitate identification. The logistical factors pertaining to the portable device 112 allow the user 102 to be tracked by way of tracking a portable device 112 belonging to the user 102. For example, suppose that the user 102 is the target 108, and the user 102 is traveling a roadway along the path 104.

The logistical factors may also specify a conveyance device 110 in the request. Here, the conveyance device 110 is illustrated as a cart but the conveyance device 110 may be any device designed to carry cargo 114 for the user 102. The user 102 may also request a companion vehicle 116 with the conveyance device 110. In some embodiments, the user 102 may specify a companion vehicle 116 or generally request a companion vehicle 116 and be assigned a companion vehicle 116 based on companion factors, such as availability, compatibility with the conveyance device 110, and/or user preference. Thus, the user 102 may request a conveyance device 110 and a companion vehicle 116 to enable the user 102 to travel the path 104 from the origin 106 to the target 108. Alternatively, the request of the companion vehicle 116 may be inferred from the one or more logistical factors, the conveyance device 110, and/or the companion vehicle 116.

The path 104 is a path between the origin 106 and the target 108. For clarity, only the origin 106 and the target 108 are demarcated on the path 104. However, a request may include one or more additional targets (e.g., destinations, stops, layovers, waypoints, locations, additional users, etc.). Therefore, a path 104 may have multiple targets. Furthermore, the path 104 may be a round trip outing that leaves from the origin 106, travels to one or more targets including the target 108, and returns to the origin 106 or one of the previously visited targets.

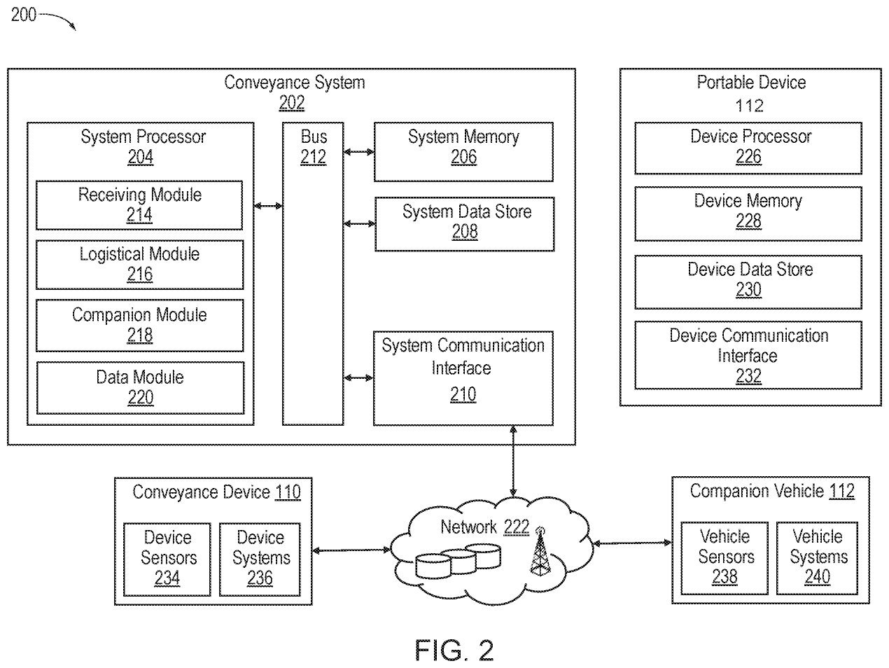

Turning to FIG. 2, the request is transmitted to a conveyance system 202, as shown in an operating environment 200. FIG. 2 is a schematic diagram of the operating environment 200 for implementing systems and methods for providing a porter service for the user 102. The components of the operating environment 200, as well as the components of other systems, hardware architectures, and software architectures discussed herein, can be combined, omitted, or organized into different architectures for various embodiments. Some components of the operating environment 200 can be implemented with or associated with a mobile application, the conveyance device 110, a portable device 112, the companion vehicle 116, or other device connected via a network (e.g., a network 222).

Generally, the conveyance system 202 includes a system processor 204, a system memory 206, a system data store 208, and a system communication interface 210, which are each operably connected for computer communication via a bus 212 and/or other wired and wireless technologies. The system communication interface 210 provides software and hardware to facilitate data input and output between the components of the conveyance system 202 and other components, networks, and data sources, which will be described herein. Additionally, the system processor 204 includes a receiving module 214, a logistical module 216, a companion module 218, and a data module 220, each suitable for providing a porter service facilitated by the components of the operating environment 200. The conveyance system 202 is also operably connected for computer communication (e.g., via the bus 212 and/or the system communication interface 210).

The conveyance system 202 is also operatively connected for computer communication to the network 222, the conveyance device 110, the portable device 112, and the companion vehicle 116. It is understood that the connection from the system communication interface 210 to the network 222, the conveyance device 110, the portable device 112, and the companion vehicle 116 can be facilitated in various ways. For example, through a network connection (e.g., wired or wireless), a cellular data network from a portable device 112, etc.

The network 222 is, for example, a data network, the Internet, a wide area network, a local area network, or cellular data network. The network 222 serves as a communication medium to various remote devices (e.g., databases, web servers, remote systems, application servers, intermediary servers, client machines, other portable devices). Thus, in some embodiments, the conveyance system 202 can obtain data from the conveyance device 110, the portable device 112, and/or the companion vehicle 116 via the network 222.

The conveyance system 202 can transmit and receive information directly or indirectly to and from the conveyance device 110, the portable device 112, and/or the companion vehicle 116, over the network 222. The portable device 112 can include a device processor 226, a device memory 228, device data store 230, and a device communication interface 232 that are configured to be in communication with one another.

As discussed above, the conveyance device 110 transports cargo 114 for the user 102. The conveyance device 110 may also provide conveyance data to the conveyance system 202. The conveyance data is associated with the user 102 using the conveyance device 110 to provide porter services. The conveyance device 110 can include integrated features, such as a computing device component (e.g., a processor, a memory, a communication interface, etc.) with logic circuitry, device sensors 234, and device systems 236.

The device sensors 234 sense and determining various parameters of the conveyance device 110, such as location data, etc. Location data may include the global position of the conveyance device 110. Additionally or alternatively, the location data may be the position of the user 102 relative to an object in the user environment 100, such as the location of the conveyance device 110 on the path 104, the location of the conveyance device 110 relative to the origin 106, the location of the conveyance device 110 relative to the target 108, or the location of the conveyance device 110 relative to the companion vehicle 116. Accordingly, the device sensors 234 may include position and motion sensors (e.g., global positioning system (GPS) sensor, accelerometer, magnometer sensors) integrated with the conveyance device 110.

The conveyance device data includes information about the operation, maintenance, historical use of the conveyance device 110. For example, the conveyance device data may include timing data associated with when the conveyance device 110 is in use or at rest, time stamped operational commands (e.g., forward, reverse, turn, reach, crouch) input by the user 102, among others. The conveyance device data may also include charging data, such as when the conveyance device 110 is low on charge, the amount of time necessary to charge the conveyance device 110, range information given a current charge, charging alerts, etc. The conveyance device data may also include maintenance information such as when the conveyance device 110 was last serviced, future service dates, or service alerts.

As discussed above, the device sensors 234 are operable to sense a measurement of user data associated with the conveyance device 110 and/or the user 102, and generate a data signal indicating said measurement of the user data. These data signals can be converted into other data formats (e.g., numerical) and/or used by the device systems 236 and/or the conveyance system 202 to generate other data metrics and parameters. It is understood that the device sensors 234 can be any type of sensor, for example, acoustic, electric, environmental, optical, imaging, light, pressure, force, thermal, temperature, biological, proximity, among others.

The conveyance system 202 can receive and/or access the user data from different sources. In one embodiment, the data module 220 receives the data from the device sensors 234. The user data may also be used by the device systems 236 to alter the manner in which the conveyance device 110 provides the porter service. The device systems 236 may, for example, include stabilization systems, positioning adjustment system, power tilt system, power recline system, adjustable height system, support system, maneuvering system, suspension system, input system, among others. The device systems 236 may include and/or be operably connected for computer communication to one or more of the device sensors 234. The companion vehicle 116 includes vehicle sensors 238 and vehicle systems 240. Vehicle data can include information related to the companion vehicle 116 including data from the vehicle sensors 238 and/or the vehicle systems 240. Exemplary vehicle data includes, but is not limited to, steering data, lane departure data, blind spot monitoring data, braking data, collision warning data, navigation data, collision mitigation data, auto cruise control data, vehicle model, vehicle make, vehicle identification number.

The vehicle sensors 238 can include, but are not limited to, vehicle speed sensors, accelerator pedal sensors, brake sensors, throttle position sensors, wheel sensors, anti-lock brake sensors, camshaft sensors, among others. The vehicle sensors 238 may also include, but are not limited to, cameras mounted to the interior or exterior of the companion vehicle 116 and radar and laser sensors mounted to the exterior of the companion vehicle 116. Further, the vehicle sensors 238 can include sensors external to the companion vehicle 116 (accessed, for example, via the network 222 of FIG. 2), for example, external cameras, radar and laser sensors on other vehicles in a vehicle-to-vehicle network, street cameras, surveillance cameras, among others.

The vehicle sensors 238 are operable to sense a measurement of vehicle data associated with the companion vehicle 116, the vehicle environment, the vehicle systems 240, and/or the user 102, and generate a data signal indicating said measurement of the vehicle data. These data signals can be converted into other data formats (e.g., numerical) and/or used by the vehicle systems 240 and/or the conveyance system 202 to generate other data metrics and parameters. It is understood that the vehicle sensors 238 can be any type of sensor, for example, acoustic, electric, environmental, optical, imaging, light, pressure, force, thermal, temperature, proximity, among others.

The vehicle data can also be received from the one or more vehicle systems 240. The vehicle systems 240 may include and/or be operably connected for computer communication to one or more of the vehicle sensors 238. The vehicle systems 240 may also be controllable based on the vehicle data and or the user data. The vehicle data and/or user data may also be used by the vehicle systems 240 to alter the manner in which the companion vehicle 116 operates. For example, suppose that the user data indicates that the user 102 and/or the conveyance device 110 is being jostled in the companion vehicle 116. The vehicle systems 240 may use this user data in conjunction with the vehicle data to alter the manner with which the companion vehicle 116 is operating by, for example, adjusting the acceleration or braking rates.

The operating environment 200, shown in FIG. 2 will now be described in operation according to an exemplary embodiment with reference to the user environment 100 of FIG. 1. As discussed above, the user 102 may desire to travel on the path 104 from an origin 106 to a target 108 and wish to request a conveyance device 110 to use along the path 104, at the origin 106, and/or at the target 108. The user 102 may use the portable device 112, shown in FIG. 2, to generate a request.

In one embodiment, the user 102 may use the portable device 112 to generate a request based on the user input at the portable device 112. The user 102 may manually input one or more logistical factors into the portable device 112 using an input device, such as a keypad, voice recognition, touch screen, etc. In some embodiments, the portable device 112 may run an application that allows the user 102 to interface with the conveyance system 202. The application may be instructions in execution on the portable device 112, firmware, software in execution on the device processor 226, and/or combinations of each to perform a function(s) or an action(s), and/or to cause a function or action from another module, method, and/or system.

In some embodiments, the request may be made by the user 102 inputting information, such as logistical factors and/or a candidate conveyance device that identifies the conveyance device 110, in a fillable form style or the information may be entered using voice recognition. The user 102 may also input the target, one or more candidate conveyance devices, and one or more candidate companion vehicles, among other transportation features that the user 102 desires for the outing. In another example, the user 102 may speak vocally list one or more logistical factors and/or transportations features to a smart speaker.

Alternatively, the user 102 may generate a request that references another source for information. For example, the user 102 may generate a request based on logistical factors from an electronic or online calendar or datebook linked to their portable device 112. For example, the user 102 may generate a request for ‘porter for Tuesday.’ Accordingly, the device processor 226 may supplement the generated request with information, including one or more additional logistical factors, from the user's calendar. In another embodiment, the device processor 226 may automatically generate a request based on predictive data that is used to identify or predict one or more logistical factors. The predictive data may be harvested from other sources such as the electronic or online calendar or datebook, historical use patterns, third party management, among others.

The request is received by the receiving module 214. The receiving module 214 identifies the one or more logistical factors, including the one or more additional logistical factors such that the receiving module 214 identifies the target 108. Suppose the request was generated using a fillable form, the receiving module 214 may segment the fillable form to extract the target 108. Likewise, the receiving module 214 may extract the target 108 from the one or more logistical factors and/or the candidate conveyance device from the other sources.

The logistical module 216 determines a logistical strategy for traversing the path between the origin and the target based on the target and a traversal mode. The traversal mode defines the approach of the conveyance device 110 to the target 108. Accordingly, the traversal mode may be based on the type of the target 108. For example, the traversal mode may distinguish between the target 108 being a user, such as the user 102, compared to the target 108 being a destination. The logistical module may access the vehicle sensors 238 and/or vehicle systems 240 of the companion vehicle 112. The logistical module 216 may determine a travel path based on maintaining the designated distance from the user, mimicking the user's path, traversing difficult surfaces (e.g. gravel), maintaining speed, and navigating through crowded areas (e.g. city sidewalks, airports, etc.) among others. The user 102 may have the option to prioritize these variables, for example prioritize speed over following the user's path exactly. Example traversal modes may include a variable follow mode, continuous follow mode, power-save mode, park mode, delivery mode, shortest path mode and/or shortest time mode. The traversal modes define one or more behavior parameters.

When the target 108 is a user the traversal modes may define that the conveyance device 110 follow the target 108 but maintain a personal radius between the conveyance device 110 and the target 108. Accordingly, the conveyance device 110 will not overrun the user 102 that is the target 108. Furthermore, the traversal mode may include a variable follow mode, continuous follow mode, or power-save mode when the target 108 is a user 102. In the variable follow mode, the conveyance device 110 may follow the user 102 to maintain a threshold distance from the user 102. Suppose the threshold distance is a range of five meters to forty meters, with a five meter personal radius for the user 102. Accordingly, when the user 102 is forty-one meters from the conveyance device 110, the conveyance device 110 will independently move to follow the user 102 until the conveyance device 110 is back within the of five meters to forty meters of the conveyance device 110.

In the continuous follow mode the conveyance device 110 may tether to the portable device 112 of the user 102, such that the conveyance device 110 mimics the movements of the user 102 following the user's path. In another embodiment, the conveyance device sensors 234 may track the user 102 or the portable device 112. For example, the conveyance device sensors 234 may use visual tracking using camera-based system, RFID tag tracking, etc. In one embodiment, the continuous follow mode includes a tether distance that is maintained by the conveyance device 110. Suppose that the tether distance is five meters. The conveyance device 110 may maintain a five meter distance from the user 102.

In the power-save mode the conveyance device 110 may minimize movements while following the user 102. The power-save mode may be triggered when the power of the conveyance device 110 falls below a power threshold. For example, the conveyance device 110 could either require approval from the user 102 or autonomously go to a charging station within designated range of the user's location, in order to recharge its power. In some embodiments, the power-save mode may be layered over another traversal mode. Suppose the power-save mode is layered over the variable follow mode, then when the user is traveling an erratic or meandering path 104, the conveyance device 110 may wait a predetermined amount of time following the user 102 leaving the threshold distance to determine if the user will re-enter the threshold distance. In another embodiment, the power-save mode may take advantage of geographic features to conserve energy of movement. For example, the logistical module 216 may identify the route with least amount of stop-start events, avoid hill climbing, take advantage of down slope (for coasting), etc. Additionally or alternatively, when in power-save mode, the logistical module 216 may identify other conveyance devices, such that multiple devices may travel together while moving toward a shared or similar target. For example, if a plurality of conveyance devices are moving toward the target 108, the plurality of conveyance devices may chain together in a detachable manner for at least a portion of the travel toward the shared or similar target.

In the park mode, the conveyance device 110 may autonomously move and park within a specific range of the user 102. For example, the logistical module 216 may set the conveyance device 110 to park within 10 minutes walking distance of the user 102. If the user 102 stays within this range the conveyance device 110 remains parked. As the user 102 moves further away from the conveyance device 110, the logistical module 216 identifies an open parking spot and directs the conveyance device 110 to move to the open parking spot within range of the user 102. The conveyance device 110 continues in this manner until the user 102 changes the mode or the target 108.

Conversely, when the target 108 is a destination, the traversal modes may include delivery mode, shortest path mode and/or shortest time mode. In the delivery mode, the conveyance device may be dispatched to a destination to pick up the cargo 114 and return to the origin 106. For example, the conveyance device 110 may be dispatched to pick-up takeout and return to the origin 106. In the shortest path mode, the conveyance device 110 may take the shortest path to the destination that is the target 108. Likewise, in the shortest time mode, the conveyance device 110 may take a fastest path based on the estimated time of arrival.

In addition to the traversal mode being based on the type of the target 108, the traversal mode may be based on one or more logistical factors, including the additional logistical factors, and the conveyance device 110. The logistical module 216 may schedule the conveyance device 110 for the user 102. For example, the logistical module 216 may schedule the conveyance device 110 based on the space requirements anticipated for the cargo 114. In one embodiment, the logistical module 216 may identify the conveyance device 110 needed by the user 102 based on the logistical factors. Likewise, the logistical module 216 may schedule the companion vehicle 116 to provide transportation on at least a portion of a path 104 between the origin 106 and target 108. The conveyance device 110 and/or the companion vehicle 116 may be scheduled based on the request, user preferences, and/or availability.

In some embodiments, the logistical module 216 may schedule the companion vehicle 116 based on the conveyance device 110. For example, the conveyance device 110 may be designed to work with a specific companion vehicle. Accordingly, when the conveyance device 110 is requested, the companion vehicle 116 designed to work with the conveyance device 110 would be scheduled as the companion vehicle 116. In some embodiments, the logistical module 216 may maintain a pairing listing of conveyance devices and companion vehicles. Furthermore, the pairing listing may include rankings for different pairings of conveyance devices and companion vehicles. The pairing listing may identify individual conveyance devices and companion vehicles or categories of conveyance devices and companion vehicles.

The logistical module 216 may schedule the conveyance device 110 and the companion vehicle 116 to arrive together at the origin 106. However, the logistical module 216 may schedule the conveyance device 110 to arrive before the companion vehicle 116, for example, to allow the user 102 to pack the conveyance device with the cargo 114. Alternatively, the logistical module 216 may schedule a detour from the path 104 to pick up the conveyance device 110, change the companion vehicle 116, accommodate a different user, traffic concerns, etc. The logistical module 216 may also schedule the conveyance device 110 to be at the target 108 having previously requested cargo at the estimated time of arrival of the user 102.

The logistical module 216 may also schedule the conveyance device 110 to be a plurality of devices. For example, the logistical module 216 may schedule both a brace and a cane as the conveyance device 110. Likewise, the logistical module 216 may schedule the companion vehicle 116 as plurality of vehicles. For example, suppose the user 102 requests round-trip transportation from the origin 106 to the target 108 and returning to the origin 106. The logistical module 216 may schedule a first companion vehicle from the origin 106 to the target 108 and a second companion vehicle from the target 108 returning to the origin 106. Accordingly, the logistical module 216 may schedule the first companion vehicle and the second companion vehicle as the companion vehicle 116.

The companion module 218 identifies a companion signal associated with the companion vehicle 116. The companion signal may provide the conveyance device 110 transportation with a location of the companion vehicle 116. The companion signal links the conveyance device 110 and the companion vehicle 116. For example, companion signal may indicate the arrival time of the companion vehicle 116. Additionally or alternatively, the companion signal may provide the conveyance device 110 with boarding instructions. For example, upon receiving the companion signal the conveyance device 110 may initiate boarding the companion vehicle 116. In one embodiment, the companion vehicle 116 may provide charging for the conveyance device 110. The companion signal may provide charging information that facilitates the conveyance device 110 receiving a charge from the companion vehicle 116.

The data module 220 generating execution data for traversing the path according to the logistical strategy. The execution data includes the information that facilitates the conveyance device 110 traversing the path 104. For example, the execution data may include directions necessary to travel the path 104, location data of the target 108, and path planning data, environment data regarding the path 104, and/or topological data. The execution data may also include user data associated with the progress of the user 102 on the path 104.

Additionally, the execution data may include conveyance device data associated with the conveyance device 110, and companion vehicle data associated with the companion vehicle 116. For example, the conveyance device data may include usage data of the conveyance device 110, error messages and/or alerts from the conveyance device 110, or charging information of the conveyance device 110 over the course of the outing. The vehicle data may include if and how the companion vehicle 116 was rerouted and why, fuel levels of the companion vehicle 116, and the timing the progress of the companion vehicle 116.

### II. Methods for Providing a Porter Service

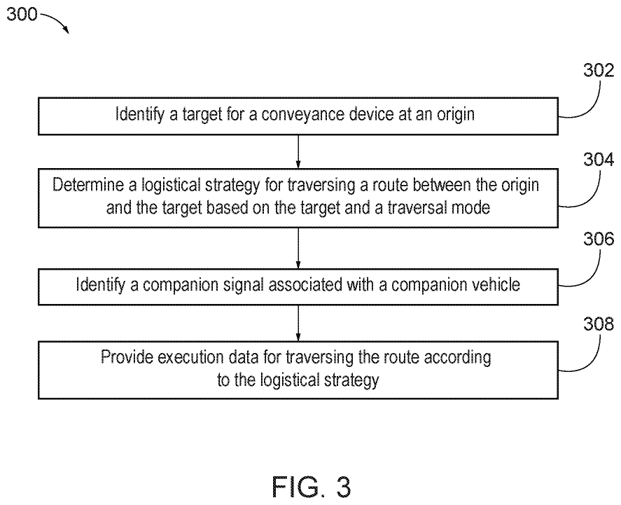

Referring now to FIG. 3, a method 300 for providing a porter service will now be described according to an exemplary embodiment. FIG. 3 will be described with reference to FIGS. 1, 2, and 4. As shown in FIG. 3, the method for providing a porter service can be described by three stages, namely, a requesting stage, a scheduling stage, and a data generation stage. For simplicity, the method 300 will be described by these stages, but it is understood that the elements of the method 300 can be organized into different architectures, blocks, stages, and/or processes.

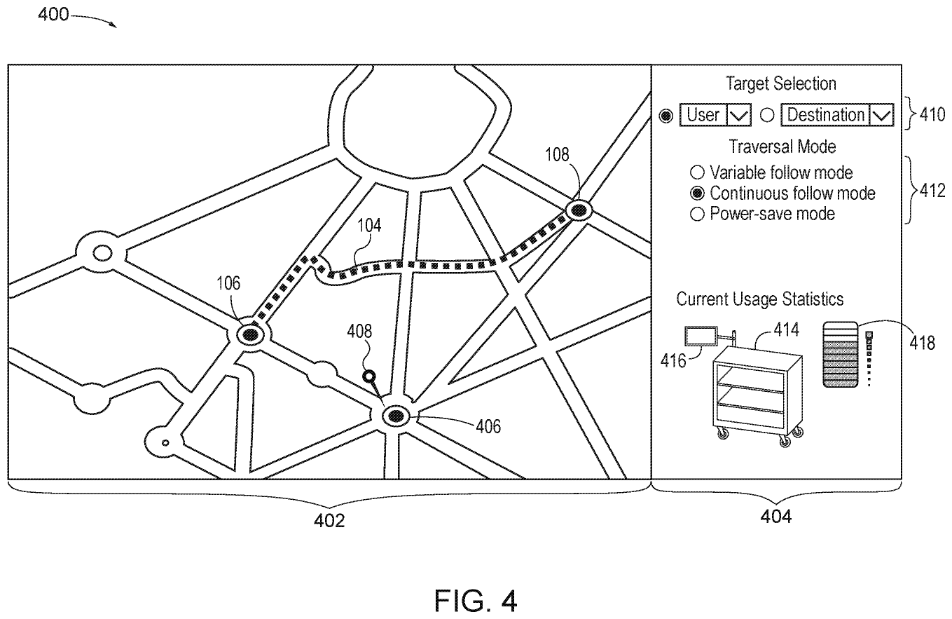

At 302, the target 108 is identified for a conveyance device 110 that is positioned at an origin 106. In some embodiments, the target 108 may be identified based on a request received from the user 102. For example, the user 102 may request a porter service using the portable device 112. Turning to FIG. 4, an exemplary interface 400 for providing a porter service according to one embodiment is provided. The interface 400 may include an interface 400. In some embodiments, the interface 400 is generated in conjunction with an application, program, or software and displayed on the portable device 112, or a display present on the conveyance device 110. The interface 400 may be modified using a touch screen or input device, such as a keyboard, a mouse, a button, a switch, voice enablement, etc.

The interface 400 may include a map area 402 and a data area 404. Here, the map area 402 and the data area 404 are shown side by side for clarity, but one or the other may be dominant in the field of view of the user 102. Alternatively, the user 102 may be able to toggle between the map area 402 and the data area 404 so that one or the other is displayed at a given time. The map area 402 and the data area 404 are exemplary nature and may rendered with different or additional features. For example, the data area 404 is shown with exemplary user data and conveyance device data, however other types of data, such as vehicle data may be additionally or alternatively included in the data area 404.

The map area 402 may be rendered based on the location of the conveyance device 110 and/or the companion vehicle 116. The map area 402 may be rendered using any of a number of network-based mapping tools available. Network-based mapping tools generally provide the user with on-demand textual or graphical maps of user specified locations. Further, several related systems may provide the user 102 with on-demand maps of automatically determined device locations based, for example, positioning technology such as satellite navigation (GPS, Galileo, Glonass, etc.) or as some function of Wi-Fi mapping, GSM-based cell signal mapping, RFID tracking, etc. For example, the conveyance device 110 may be tracked based on the device systems 236 including satellite navigation. In another example, the user 102 may be tracked by tracking the portable device 112. The portable device 112 may be tracked by using signal triangulation from nearby cell towers to pinpoint the location of the portable device 112. Similarly, Wi-Fi mapping may locate the user 102 by evaluating signal samples from multiple access points.

In this manner, the map area 402 can be rendered by tracking the user 102 or one or more of the device associated with the request, such as the conveyance device 110, the portable device 112, and/or companion vehicle 116. The map area 402 can be rendered to illustrate a predetermined area centered on the user 102, the path 104, the origin 106, the target 108, the conveyance device 110, the portable device 112, or companion vehicle 116 as selected by the user 102.

In one embodiment, the map area 402 may be displayed on the portable device 112 so that a user can generate a subsequent request while the user is traveling the path 104. Suppose the user 102 requested the path 104 between the origin 106 and the target 108, as shown in FIG. 1. The user may wish to add a stop such as waypoint 406. The user 102 can select the waypoint 406 by placing a target indicator 408 in the map area 402. When the user 102 alters the path 104 in this manner, the data area 404 may show a request generator, which may be a fillable form or voice recognition interface. In the request generator may provide a target selection 410 that allows the user 102 to select between different types of target. For example, the target selection 410 may include menus, such as drop down menus, for user-type candidate targets or destination-type candidate targets. Furthermore, the data area 404 may also include a traversal mode selection 412. In the traversal mode selection 412, the user 102 can select the traversal mode for the conveyance device 110 based on the target selected in the target selection 410.

As illustrated, the data area 404 may show a schematic 414 of the conveyance device 110 in the position and/or orientation that the conveyance device 110 is placed in real-time. In some embodiments, the device systems 236 of the conveyance device 110 may be in computer communication with the interface 400 such that alterations to the schematic 414 cause a corresponding change to the conveyance device 110. For example, if the conveyance device 110 is open, then the schematic 414 would be illustrated as open as well. As another example, a monitor 416 illustrated with the schematic 414 may be selected to control a corresponding display of the conveyance device 110. The monitor 416 may be used as a user input, or used to display a destination, route, advertising, indication of availability, charge state, etc.

While the schematic 414 corresponds to the conveyance device 110 here, the schematic 414 could also be of the companion vehicle 116, and thus changes to the schematic 414 would be in computer communication with the vehicle systems and cause changes to the companion vehicle 116, for example, turning on an infotainment center, changing the volume of the radio, turning on the air conditioner, etc. Accordingly, the controls for the vehicle systems 240 may be accessible using a schematic of the companion vehicle 116.

The data area 404 may also show conveyance device data or vehicle data. For example, a status bar 418 may indicate the charging information including the charge status of the conveyance device 110. The schematic 414, and the status bar 418 are exemplary in nature, and the data area 404 may have one, some, or none of them displayed. Instead, the user 102 may have a porter service dashboard displayed in the data are 604 that the user 102 has customized to be suited the needs of the user 102. Moreover, as described the data area 404 as well as the map area 402 may be dynamic in nature and change to meet the preferences or expectations of the user 102.

Returning to FIG. 3, at block 304, the method 300 includes determining a logistical strategy for traversing the path 104 between the origin 106 and the target 108 based on the target and a traversal mode. The traversal mode defines behavior parameters of the conveyance device 110 transportation while traversing the path 104. In some embodiments, the traversal mode is based on the type of the target. Additionally or alternatively, the traversal modes may be layered such that a plurality of traversal modes can be used together.

At block 306, the method 300 includes identifying a companion signal associated with a companion vehicle. The companion signal links the conveyance device 110 and the companion vehicle 116 so that the conveyance device 110 are capable to work together with the companion vehicle 116. For example, the companion signal may identify the location of the companion vehicle 116 relative to the conveyance device 110. The companion signal may also define movements for the conveyance device 110 and/or the companion vehicle 116 relative to each other.

At block 308, the method 300 includes generating execution data for traversing the path according to the logistical strategy. The execution data provides granular directions for operation of the conveyance device 110. For example, the execution data may include step-by-step directions. The companion vehicle 116 provides the conveyance device 110 transportation on at least a portion of the path 104.

The embodiments discussed herein may also be described and implemented in the context of non-transitory computer-readable storage medium storing computer-executable instructions. Non-transitory computer-readable storage media includes computer storage media and communication media. For example, flash memory drives, digital versatile discs (DVDs), compact discs (CDs), floppy disks, and tape cassettes. Non-transitory computer-readable storage media may include volatile and nonvolatile, removable and non-removable media implemented in any method or technology for storage of information such as computer readable instructions, data structures, modules, or other data. Non-transitory computer readable storage media excludes transitory and propagated data signals.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for providing a porter service with a conveyance device used to carry cargo on behalf of a user, comprising:
receiving a target for the conveyance device at an origin;
determining a logistical strategy for traversing a path between the origin and the target based on the target and a traversal mode;
identifying a companion signal associated with a companion vehicle; and
generating execution data for traversing the path according to the logistical strategy, wherein the companion vehicle provides the conveyance device with transportation on at least a portion of the path.

2. The computer-implemented method of claim 1, wherein the target is a user, and wherein the computer-implemented method further comprises tracking the user.

3. The computer-implemented method of claim 2, wherein the tracking is based on a portable device associated with the user.

4. The computer-implemented method of claim 2, wherein the logistical strategy includes following the user.

5. The computer-implemented method of claim 1, wherein the target is a destination.

6. The computer-implemented method of claim 5, wherein the logistical strategy includes generating directions to traverse the path.

7. The computer-implemented method of claim 5, wherein the logistical strategy includes retrieving an item from the destination.

8. The computer-implemented method of claim 1, wherein the traversal mode defines behavior parameters of the conveyance device with transportation while traversing the path.

9. The computer-implemented method of claim 8, wherein the behavior parameters include following distance.

10. The computer-implemented method of claim 1, wherein the companion signal provides the conveyance device with transportation with a location of the companion vehicle.

11. A system for providing a porter service with a conveyance device used to carry cargo on behalf of a user, the system comprising:
a receiving module configured to receive a target for the conveyance device at an origin;
a logistical module configured to determine a logistical strategy for traversing a path between the origin and the target based on the target and a traversal mode;
a companion module configured to identify a companion signal associated with a companion vehicle; and
a data module configured to providing execution data for traversing the path according to the logistical strategy, wherein the companion vehicle provides the conveyance device with transportation on at least a portion of the path.

12. The system of claim 11, wherein the target is a user, and wherein the logistical strategy includes following the user.

13. The system of claim 11, wherein the target is a destination, and wherein the logistical strategy includes retrieving an item from the target.

14. The system of claim 11, wherein the traversal mode defines behavior parameters of the conveyance device with transportation while traversing the path.

15. The system of claim 11, wherein the companion signal provides the conveyance device with transportation with a location of the companion vehicle.

16. A non-transitory computer-readable storage medium storing instructions that, when executed by a computer, causes the computer to perform a method comprising:
receiving a target for a conveyance device at an origin, wherein the conveyance device contains one or more items of cargo for a user;
determining a logistical strategy for traversing a path between the origin and the target based on the target and a traversal mode;
identifying a companion signal associated with a companion vehicle; and
generating execution data for traversing the path according to the logistical strategy, wherein the companion vehicle provides the conveyance device with transportation on at least a portion of the path.

17. The non-transitory computer-readable storage medium of claim 16, wherein the target is a user, and wherein the logistical strategy includes following the user.

18. The non-transitory computer-readable storage medium of claim 16, wherein the target is a destination, wherein the logistical strategy includes retrieving an item from the destination.

19. The non-transitory computer-readable storage medium of claim 16, wherein the traversal mode defines behavior parameters of the conveyance device with transportation while traversing the path.

20. The non-transitory computer-readable storage medium of claim 16, wherein the companion signal provides the conveyance device with transportation with a location of the companion vehicle.
